(19) United States
(12) Patent Application Publication
(10) Pub. No.: US 2003/0233601 A1
(43) Pub. Date: Dec. 18, 2003

(54) Non-intrusive signal observation techniques usable for real-time internal signal capture for an electronic module or integrated circuit

(76) Inventors: Kushagra V. Vaid, San Jose, CA (US); Piyush Desai, Pleasanton, CA (US); Victor W. Lee, San Jose, CA (US)

Correspondence Address: Jeffrey S. Draeger, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/174,322

(22) Filed: Jun. 17, 2002

(51) Int. Cl. H04L 1/22

(52) U.S. Cl. 714/42

(57) ABSTRACT

Internal bus observation techniques for an electronic module or integrated circuit. In one embodiment, a disclosed apparatus includes observation logic to observe an observed bus and a debug buffer. The observation logic captures a record reflecting signal observed on the observed bus. The debug buffer is coupled to the observation logic to receive the record that reflects signal observed by the observation logic. The debug buffer generates a transaction to transfer the record to a storage device to store the record.

### BACKGROUND

1. Field

The present disclosure pertains to the field of testability and observation techniques for an electronic component such as a module or an integrated circuit.

2. Description of Related Art

As electronic component complexity continues to rise, the ability to track the internal sequencing of operations continues to drop. This loss of visibility into the inner workings of a component disadvantageously complicates the process of debugging problems encountered. Accordingly, improving visibility may desirably assist those debugging the component itself, systems using the component, or software programs.

One prior art mechanism often used to improve internal visibility is a scan chain. A scan chain provides a snapshot of a number of internal serially linked nodes. Traditional scan chains provide a single capture window to capture state at a specified point in time. Some scan chains can also be run in linear feedback shift register (LFSR) mode, in which results are logically compounded (typically exclusive-ORed) to derive a final checksum; however this mode does not preserve the intermediate data points for each node.

Another prior art technique for observing internal component operation is the use of a history buffer. A history buffer is generally a relatively small, dedicated hardware buffer in the processing device which captures a short sequence of processor state or other program flow information. Results may be retrieved from a typical history buffer via special test debug commands or other specialized debug mechanisms.

According to another prior art technique, a limited amount of program flow or execution flow information may be tracked by some processors by outputting such information (e.g., branch trace messages) via external pins when executing in a special debug mode such as an in-circuit-emulation mode. However, these techniques only typically output a few signals to pins due to the difficulties and/or cost of dedicating or multiplexing pins for this purpose. Thus, only very limited information about the internal operations can be provided using this technique, and some external test device is needed to store information output by the device. Furthermore, as internal component speeds often now eclipse the external or bus speeds of such components, outputting internal signals to pins may be difficult or entirely impractical in some cases.

A further prior art technique for observing internal component operation is the use of breakpoints. Breakpoints are generally points at which normal program execution is interrupted and a breakpoint routine is executed. The breakpoint routine can capture the state of the processor or other static information present at the time the breakpoint interrupt occurs. However, a breakpoint interrupts execution and does not allow capture of a continuous sequence of events, but rather relies on iterating through test and breaking at different points. Thus, breakpoint use does not capture a sequence of data as it occurs.

### BRIEF DESCRIPTION OF THE FIGURES

The present invention is illustrated by way of example and not limitation in the Figures of the accompanying drawings.

FIG. 1 illustrates various features of one embodiment.

FIG. 2a is a flow diagram illustrating signal capture techniques according to one disclosed embodiment.

FIG. 2b illustrates additional process details including information regarding one embodiment of a technique for reduction of the quantity of data observed in generating a record of the observed data according to one embodiment.

FIG. 2c illustrates further details of preservation of observed information according to one embodiment.

FIG. 2d illustrates further details of preservation of observed information according to another embodiment.

FIG. 2e illustrates further details of preservation of observed information according to another embodiment.

FIG. 3a illustrates one embodiment of a system employing disclosed signal capture techniques.

FIG. 3b illustrates one embodiment of a processor including signal observation logic according to disclosed techniques.

FIG. 4 illustrates another embodiment of a processor including signal observation logic according to disclosed techniques.

FIG. 5 illustrates an embodiment of a system employing at least one processor utilizing disclosed signal observation techniques and a node that may be dedicated to storing data from such observation.

### DETAILED DESCRIPTION

The following description describes embodiments of non-intrusive signal observation techniques which may be usable for real-time internal signal capture for an electronic module or integrated circuit. In the following description, numerous specific details are set forth in order to provide a more thorough understanding of the present invention. It will be appreciated, however, by one skilled in the art that the invention may be practiced without such specific details.

In some embodiments, disclosed techniques advantageously enable large scale, real time capture of internal signals of an electronic component when otherwise such signals are difficult to observe due to the inability to probe such signals. In contrast to snapshot approaches such as scan chains or history buffers, some embodiments allow capture of a relatively large sequence of signal information as it occurs, rather than through repeated test execution, by using relatively large system memories to store data real time. Various embodiments rely on various system memories (e.g., a node a memory, some cache memory in the system, or a remote system memory) to preserve captured data, thereby allowing some embodiments to operate in a substantially normal system environment, allowing more realistic testing of the device under test.

In some embodiments, such signal capture is considered non-intrusive, because no probes, logic analyzers, or the like are needed to capture such information. Rather, logic internal to the component captures data and prepares the data for preservation in a memory from which it can be readily retrieved by relatively straightforward memory access techniques. Non-intrusive capture may be highly advantageous as higher levels of integration reduce visibility of important buses. Additionally, extremely high frequency but externally visible buses may also be better observed by non-intrusive techniques which avoid adding loads to and therefore potentially disrupting external buses.

Throughout this specification, observation of a “bus”, capture of data from a “bus”, and the like are described. The term bus is not intended to be limiting in the sense of a strictly related set of signals that defines a quantity such as an address, a data value, etc. Rather, as referred to herein, a bus may refer to any group of signals. Such group of signals may be a group of signals that forms inputs and/or outputs of a state machine, a logic block, or some other grouping of signals. A logic block may be a block of combinational logic, or a larger functional block such as an ALU, a control circuit, or the like, or may be an entire processor or other device.

Additionally, when a “system memory” is referred to, this term refers to a memory that is within or forms an operational component within the component or system being tested. Thus, a memory in a separately operable test device such as a logic analyzer or oscilloscope is not a part of the system. A system memory can be used in normal system operations, which are operations performed as a part of operation of a system or component beyond merely testing of the system or component itself. In a test mode, one or more particular system memories may be partitioned for partial test usage or completely dedicated to capture debug information.

Additionally, some embodiments may be said to effect “real time” capture, storage, or observation of signals. Such real time activity implies a continuum of events and not necessarily simultaneity of occurrence and storage. Real time implies that events or operations need not be slowed down to accommodate the test/debug feature, again not simultaneity. For example, values may be in the process of being latched from the observed bus while previous values are being stored in a memory. This observing and storing continues as the component operates at a normal or acceptable speed, not unduly slowed down to allow data capture. Some embodiments will be simultaneously storing values in memory and capturing other values over a period in time, but this does not necessarily imply that the values stored are stored at the time that they first appear. Similarly, for values or sequences to be captured, observed, or stored “as they occur” does not require simultaneous action, but rather implies that sufficient action is taken to preserved the values or sequence.

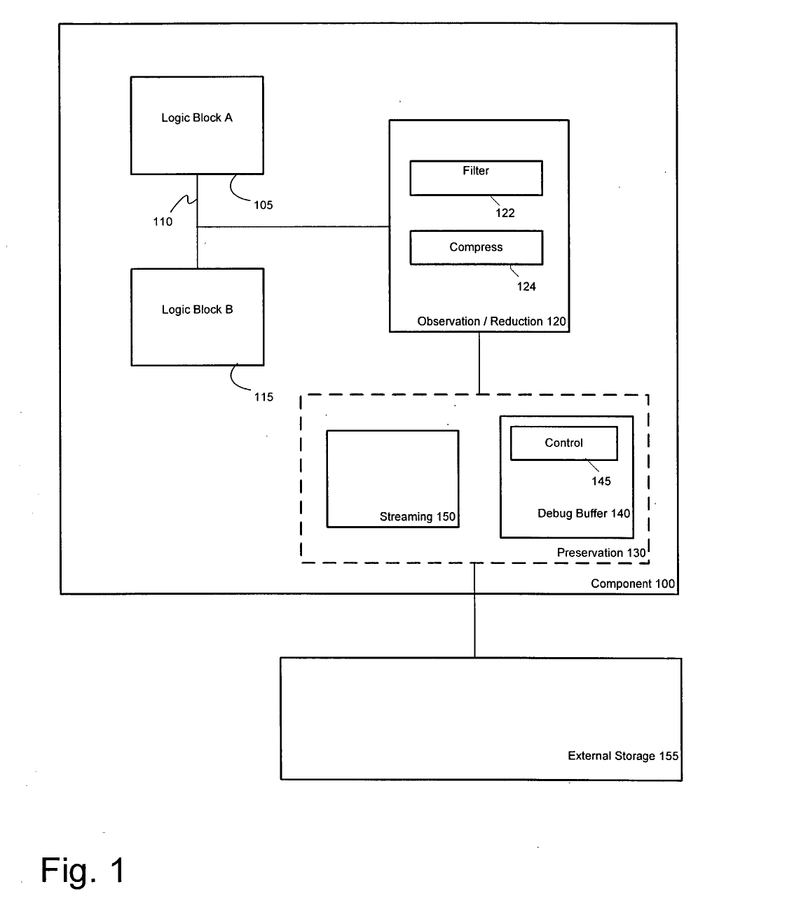

FIG. 1 illustrates of a component 100 which may employ various ones of disclosed bus observation techniques. In FIG. 1, the component 100 includes logic block A 105, logic block B 115, and a bus 110 coupling logic block A and logic block B. In one embodiment, a sequence values from the bus 110 may be observed and recorded in real time for later analysis. Accordingly, the component 100 includes observation and/or reduction logic 120 which is coupled to the bus 110. Coupled to the observation/reduction logic 120 is preservation logic 130. The preservation logic 130 generally directs the storage of the records captured by the logic 120 in a system memory.

As previously discussed, the bus may be any group of signals, and the logic blocks may be anywhere from a very limited set of logic gates to a processor, a bridge, or other component, module, or combination. Internal buses may be tracked in a component which integrates traditional buses, making them difficult to observe by intrusive means such as interposer cards, logic analyzers, oscilloscopes, and the like. In an alternative embodiment signals on an externally available but very high speed bus may also be tracked via capture of internal signals which can be captured more easily and reliably without perturbing operation of the external bus.

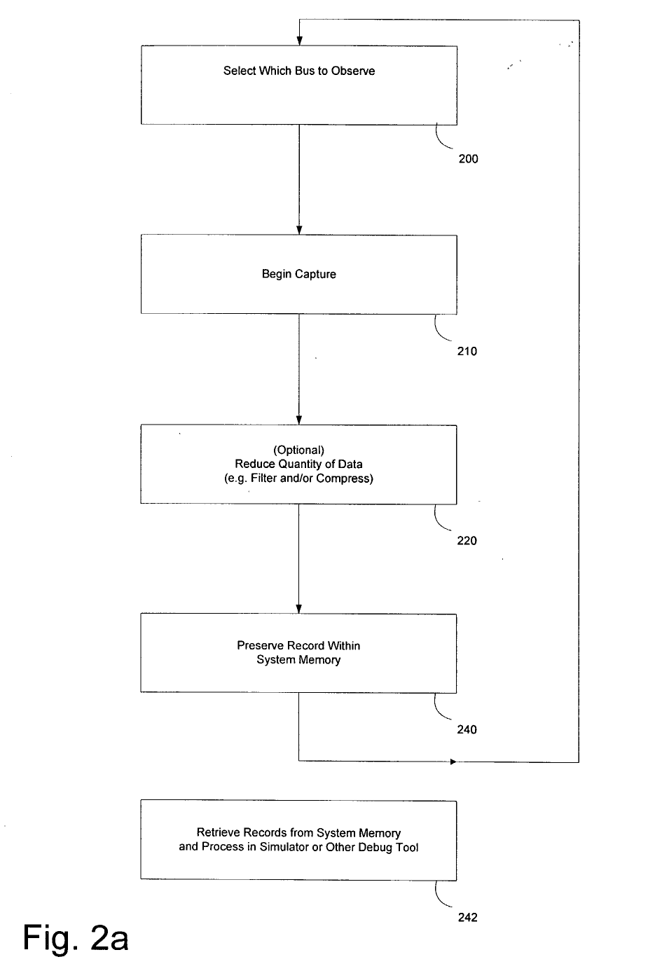

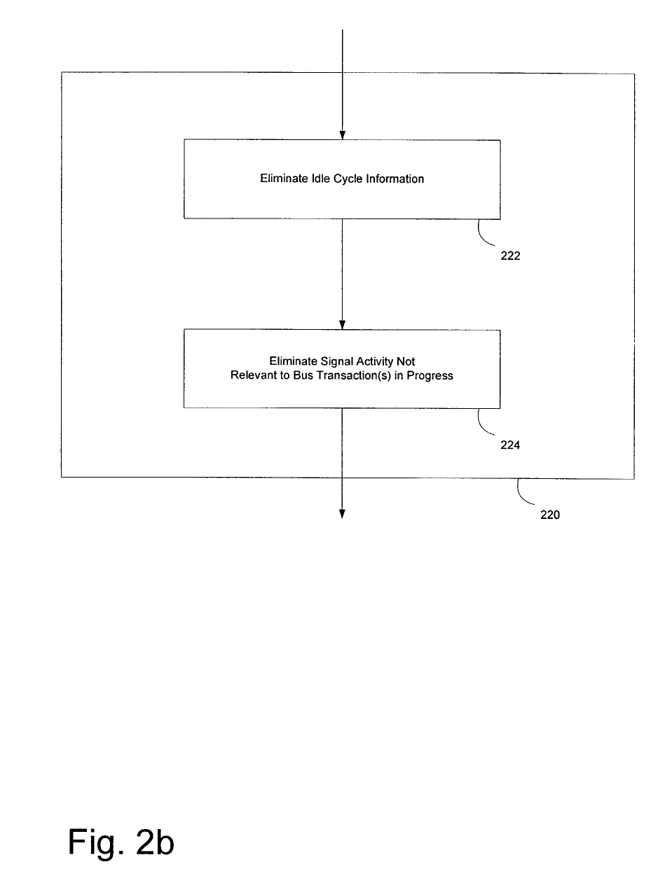

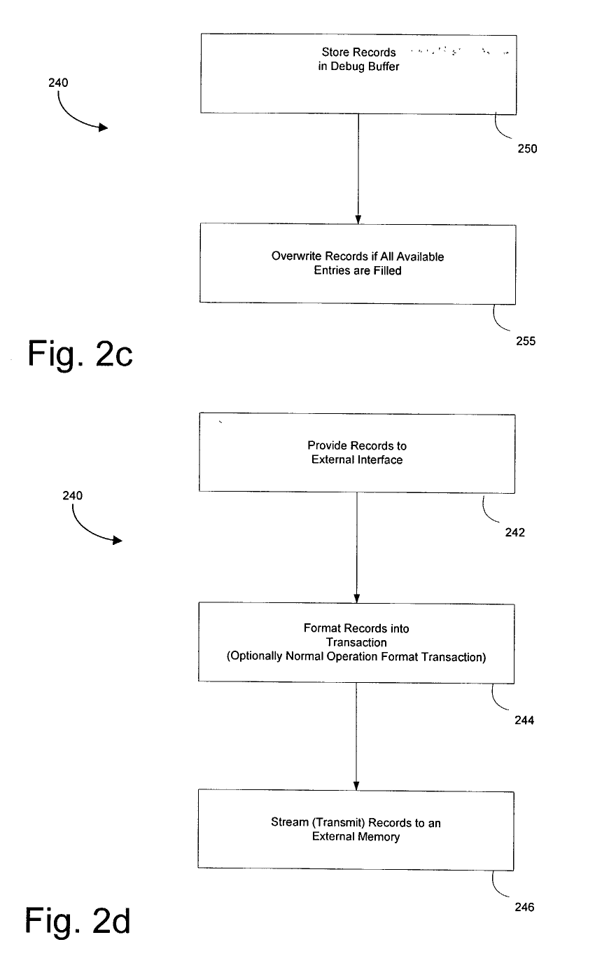

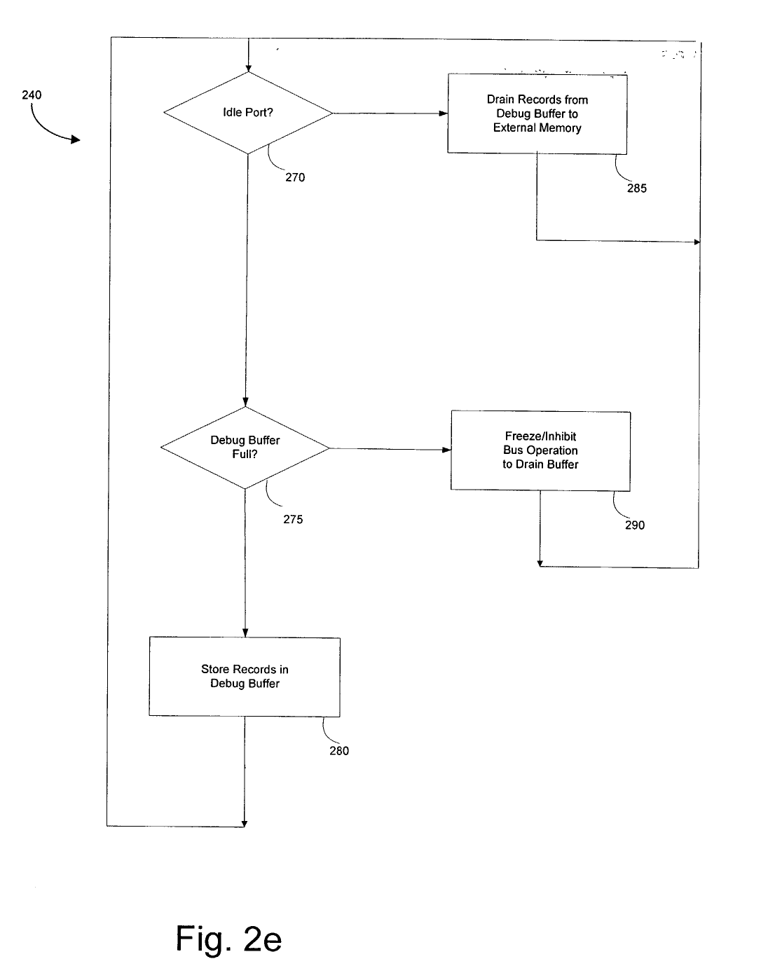

FIG. 2a is a flow diagram illustrating signal observation techniques according to one embodiment. The features in FIG. 1 will be further discussed with reference to the process in FIGS. 2a-2e. Some embodiments allow various different buses to be observed, so in block 200 the bus to observe is selected. For the purposes of this example, it is assumed that bus 110 is selected, but other buses could be observed. In block 210, capturing of signals on the bus 110 begins. Any known or otherwise available triggering may be used to initiate this capturing. For example, either hardware or software triggers may be employed.

Once the observation commences, the observation/reduction logic 120 captures a record of data on the bus. Records are any quanta of captured data and may relate to individual clock cycles, bus cycles, bus transactions, or some other quanta of time or data. Records may be time stamped with a cycle number, such as a bus cycle number, and a counter may be used to track the record number. Records may or may not have predetermined sizes, and may or may not be explicitly separated by markers or the like, depending on the storage mode used.

In one embodiment, the logic 120 may simply capture raw data from the bus 110 into a set of records. In one mode, it may be desirable to capture a complete picture of all meaningful activity on the bus 110. The data may be captured with reference to a signal such as a clock signal that may be present on the bus 110. Capturing each and every bit of data on the bus in each cycle is one technique that may be used to capture a complete picture of all meaningful activity on the bus; however, in some embodiments, the bus 110 may be a high frequency bus and may have a large number of signals, making full capture in real time quite bandwidth intensive if not prohibitive.

Therefore, the logic 120 may have intelligence about the types of transactions or cycles that occur on the bus. Such intelligence may allow the logic 120 to reduce the number of bits needed to accurately reflect all relevant information from each event, each clock cycle, or each transaction. Any reduction technique may be used such that the records for a sequence contain fewer bits than the sum of all bits for each and every bit of the bus for every cycle in the observed sequence. For example, depending on the type of transaction, certain bits may have no defined meaning at certain points in time, and the logic 120 may omit collection of such bits. Another example is that idle cycles could be eliminated. Another example is that compression techniques could be used since typically not every signal on a bus changes every cycle.

FIG. 2b illustrates one embodiment in which the reduction of block 220 includes both filtering and compression. The embodiment of FIG. 2b may be particularly applicable to the case where the bus 110 is an internal bus having defined bus transactions. For example, the bus 110 may be a bus between a logic block such as a processor and another logic block such as a bus bridge controller, although other blocks that communicate via a protocol may be appropriate for similar data reduction as well. In block 222, idle cycles, such as bus clocks in which no logic block is driving the bus, may be eliminated by filter logic 122. In block 224, signals not relevant to bus transaction(s) in process may be eliminated by compression logic 124. Thus, for example, idle bus cycles may be eliminated according to this embodiment, as well as signals on the bus that are not defined or not relevant during the particular transaction or phase of the transaction that is occurring. In this manner, a more compact set of records capturing a complete picture of the bus activity may be generated.

In another mode, the logic 120 may not attempt to capture all meaningful information on the bus, but rather may capture a subset of this information. For example, the logic 120 may capture each new address driven, or each new data element driven or received, or may track other information. For example, it may be useful to track a set of information that allows tracking of instruction execution. For example, internal state variables of a processor may be tracked. Alternatively, memory access and/or traditional bus transaction information may be summarized by capturing a subset of signals at various protocol-defined points in time.

Regardless of the specific record generation technique, the preservation logic 150 preserves the records within a system memory as indicated in block 240 of FIG. 2a. The preservation block generally produces control signals to direct the storage of the records captured by the logic 120 and/or actually stores the records in a system memory. The system memory may be one of a variety of system accessible memories, otherwise used in normal operation, that are partially or fully dedicated to trace capture in a test mode. In one embodiment, a debug buffer 140 is included to store the traces captured. The debug buffer 140 may be a portion or all of a cache memory on the component 100. Control logic 145 of the debug buffer 140 may partition the cache appropriately and also may control storage of traces into the debug buffer (e.g., to use one way of the cache for trace capture).

FIG. 2c illustrates a sequence of operations for one embodiment that uses a debug buffer to store records of captured bus data. In this embodiment, as indicated in block 250, records are stored in the debug buffer 140. Since the debug buffer 140 may be an on-chip or on-component cache, the debug buffer 140 clearly may be of limited size. Therefore, bus observation may use the entirety of the allocated portion of the memory. If the debug buffer reaches its capacity, it is treated as a circular buffer in this embodiment, and records are overwritten once the available space is filled, as indicated in block 255. In another embodiment, the debug buffer 140 stops capturing records when full.

In another embodiment, the records of captured traces are sent to system memories off of the component. In this embodiment, streaming logic 150 performs the function of writing records by generating control signals to cause records to be written to an external storage 155. Operations for one such embodiment are shown in FIG. 2d. In the embodiment of FIG. 2d, the records are provided to the external interface (e.g., the streaming logic 150) for transfer to the external storage 155 as indicated in block 242. The external storage 155 may be a node memory associated with the component 100, another cache memory, a system memory, a main memory, or any other type of memory that might normally be accessible by the component 100.

The streaming logic 150 formats the records into a transaction as indicated in block 244. In one embodiment, the streaming logic 150 is logic that may also be used by the component 100 in a non-test/debug mode (i.e., during normal operations). Therefore, the streaming logic 150 may generate write transactions according to a protocol that is used during a normal operation mode. The protocol may be any bus interface, memory interface, or point-to-point link interface protocol, etc., whereby data may be written to a memory, directly or indirectly. The streaming logic then streams or writes the records to the memory as indicated in block 246.

Thus, the debug buffer 140 and the streaming logic 150 may be used independently and exclusively. That is, an embodiment may have only streaming logic 150 to send a stream of captured traces to memory in real time, or may have only a debug buffer to capture a stream of traces in real time. Such an embodiment may just have one piece of preservation logic, meaning one or the other of the streaming logic 150 and the debug buffer 140. However, a hybrid approach may also be used.

FIG. 2e illustrates a sequence of operations in one embodiment of such as hybrid approach. The approach shown in FIG. 2e may be considered to be non-interfering with respect to system operations because it only uses idle cycles to stream data to the external memory. Whether an idle port is available (i.e., whether there is an opportunity to generate an external transaction) is tested in block 270. If there is an idle port available, records are drained from the debug buffer 140 as indicated in block 285. Also, if the debug buffer 140 has been emptied, records could be immediately streamed from the observation/reduction logic 120 in some embodiments. After one or more records are drained (according to the quanta of idle port capacity available), the process returns to block 270 to determine if an idle port is still available.

If, in block 270, no idle port is found, then a second test to determine whether the debug buffer 140 is full may be performed as indicated in block 275. If the debug buffer 140 is not full, then record(s) are stored in the debug buffer 140 as indicated in block 280. If, on the other hand, the debug buffer 140 is full, then a freeze or inhibit signal may be generated to inhibit operation of the component such that the debug buffer 140 can be drained without interfering with actual system transactions while they are occurring as indicated in block 290.

In another embodiment where it is not as crucial to avoid interfering with system operation, the streaming logic 150 could prefer system transactions to transactions from the debug buffer 140, at least until the debug buffer 140 reaches a threshold indicating that it is nearing capacity. Such a technique might avoid the need to stall the component, yet still would try to minimize interference with normal system operation. In yet another embodiment, the debug buffer 140 could be a circular buffer which overwrites other information to avoid interference with system operation or could simply stop recording information when full when idle port time is not available. In such case, a second trace could be taken from a later point in time to capture the relevant information in the debug buffer 140. In some embodiments, these and other various options for on-component and off-component capture and storage may be selectable by configuration options. Thus, various methods may be chosen to preserve captured traces of bus activity. These traces may be later used in system debug and analysis. As indicated in block 242 of FIG. 2a, the records will typically be retrieved from the system memory and processed in a simulator or other debug tool or system. The traces can conveniently be retrieved by memory access commands that allow the system to access its own memory in this embodiment.

In some embodiments, reliance on relatively large system memories may enable the capture an extensive amount of real time data regarding operations. For example, in one embodiment, an entire interface between a memory controller or bus bridge logic block and a processor may be captured, including address, data, and control information sufficient to fully reproduce all bus transactions that that occur on the internal bus during the time period in which capture is performed. Such traces may be retrieved by reading them out of the system memory. The traces may then be input to a simulator to observe the expected states of other internal nodes. Such an approach may be particularly helpful when a processor is integrated with other components, such that previously existing models and test suites may be leveraged despite the fact that the processor is integrated and its front side bus no longer is directly observable.

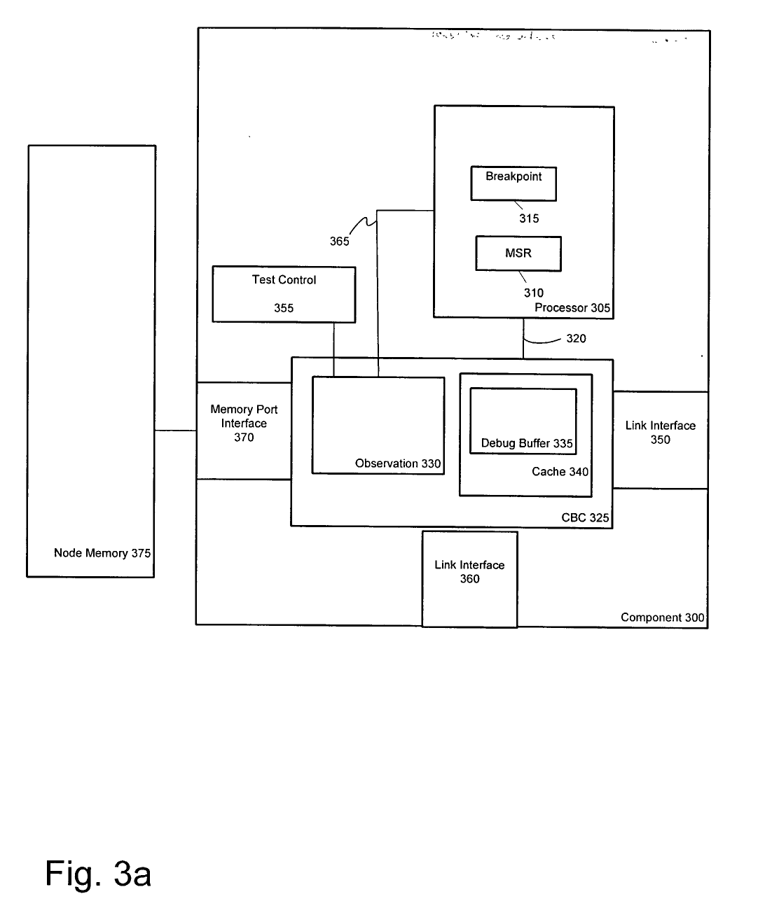

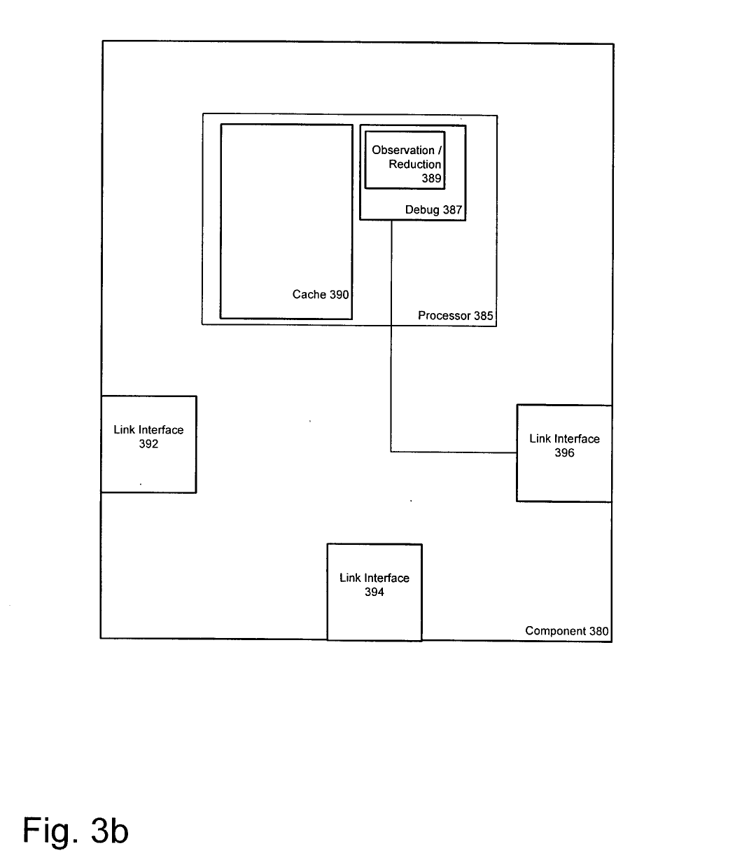

FIG. 3a illustrates one embodiment of a system employing disclosed signal capture techniques. In the embodiment of FIG. 3a, a component 300 includes a processor 305 and a caching bridge controller (CBC) 325. The processor 305 includes a machine specific register 310 and a breakpoint register 315. A bus 320 couples the processor 305 to the caching bridge controller 325. The bus 320 is a Front Side Bus (FSB) that conveys various bus transactions between processors and bridges or memory controllers as is known in the art. In this case, however, the bus is unavailable to traditional intrusive techniques such as probing because the entire component 300, including the processor 305 and the CBC 325 is either integrated within a module or onto a single piece of silicon, making the bus 320 an internal bus. Without the ability to observe the bus 320, such integration would greatly complicate debug of the component 300.

In this embodiment, the CBC includes a cache 340. In one embodiment, the cache may be a directory cache, but in other embodiments other types of caches may be present and may be used. The cache 340 is partitioned in debug mode to have a debug buffer 335. The debug buffer 335 communicates with observation logic 330 to receive records of activity from the bus 320 for storage.

The component 300 also includes several link interfaces 350 and 360. These interfaces may be used to connect with other processor modules or Input/Output (I/O) controllers, or other agents. The component 300 also includes a memory port interface 370. The memory port interface 370 couples the component 300 to a node memory 375. Any known or otherwise available protocol may be used to couple these components.

The component 300 may operate to capture debug traces in any of the modes previously described. Therefore, the observation logic 330 may store traces or records of traces directly in the debug buffer 335, may stream data to any one or more of the memory port interface 370, the link interface 350 or the link interface 360. Moreover, a hybrid approach using both streaming and buffering may be used. Furthermore, various generally known and/or previously discussed data reduction, compression, etc., techniques may be used prior to storing or streaming the data.

Furthermore, the component 300 may be configurable to observe different buses or signals as may be desirable. For example, the component 300 may be configurable to observe bus traffic on one or more of the memory port interface 370, the link interface 360, or the link interface 350 via observation of internal signals reflective of signals on the external signal lines. The component may be configured by various techniques. The breakpoint register 315 may be used to specify an address at which a breakpoint signal may be sent on a signal line 365 to the observation logic 330 to commence observation. Alternatively, the observation logic 330 could be programmed to trigger on a certain bus sequence as it is observing the bus. Such programming could be performed through test control logic 355. For example, the test control logic 355 may be a Test Access Port (TAP) controller, under the IEEE 1149.1 Standard (e.g., IEEE std. 1149.1-1990, published Feb. 15, 1990), with one or more special instructions to handle such programming. Additionally, the machine specific register 310 in the processor, or other software programmable registers (not shown) in the processor or CBC 325 could be programmed by conventional techniques to control triggering and the observation target and mode.

FIG. 3b illustrates another embodiment of a component 380, where a processor 385 portion includes debug logic 387 to allow real time capture of traces. In this embodiment a processor cache 390 may be used as a buffer to capture data. The processor 385 of FIG. 3b includes debug logic 387 that includes observation logic 389. The debug logic 387 is shown as coupled to a link interface 396, and may indeed be also coupled to other link interfaces 392 and 394. The cache 390 may be partitioned to provide a debug buffer. A memory controller or bridge controller may or may not be included. Any of the various combinations with respect to capturing and/or storing the captured trace data may be used in this embodiment.

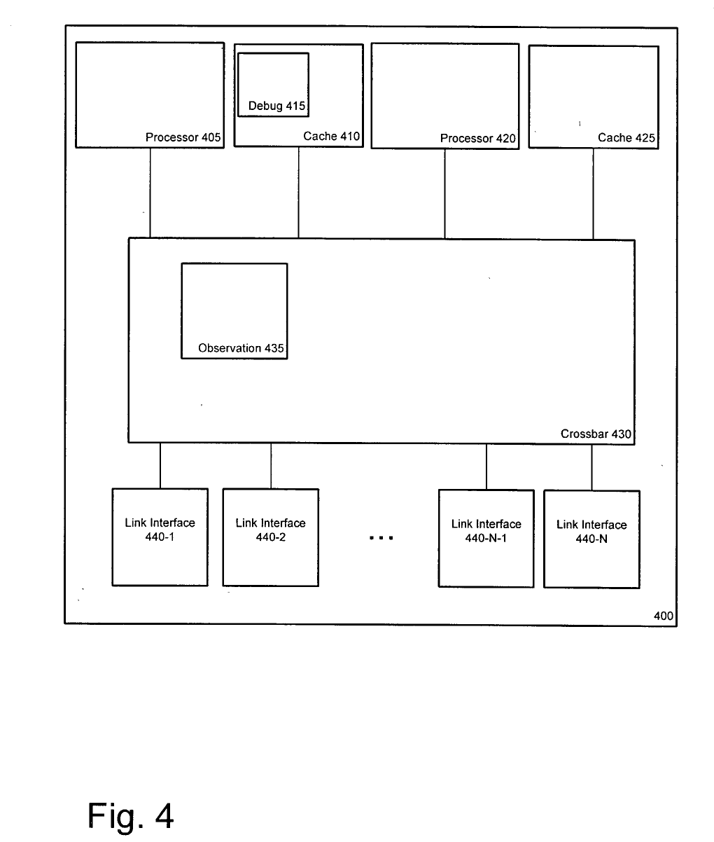

FIG. 4 illustrates another component that may benefit from disclosed techniques. A component 400 shown in FIG. 4 includes a variety of sub-components linked by a crossbar 430. Since all of these sub-components are linked via an internal mechanism, it may be otherwise difficult to observe the activities of the individual sub-components. Therefore observation logic 435 is included. The observation logic 435 may observe any of the various internal links to the crossbar 430, and then either store trace data in a cache or other memory (not shown), or stream data to a system memory external to the component 400.

In one embodiment, the component 400 is a chip multiprocessor that includes two processors, (processor 405 and processor 420), two caches (cache 410 and cache 425), and a plurality (N) of link and/or memory interfaces (LI 440-1 through 440-N). In this embodiment, a portion of one of the caches may be used to buffer trace records. For example, a debug portion 415 may be partitioned from cache 410 in a debug mode. Additionally, streaming via any one or more of the link interfaces may be used alone or in conjunction with cache buffering of trace records if desired. Other configurations of chip or module multiprocessors may also benefit from the use of disclosed techniques because the high level of integration makes many signals difficult to observe.

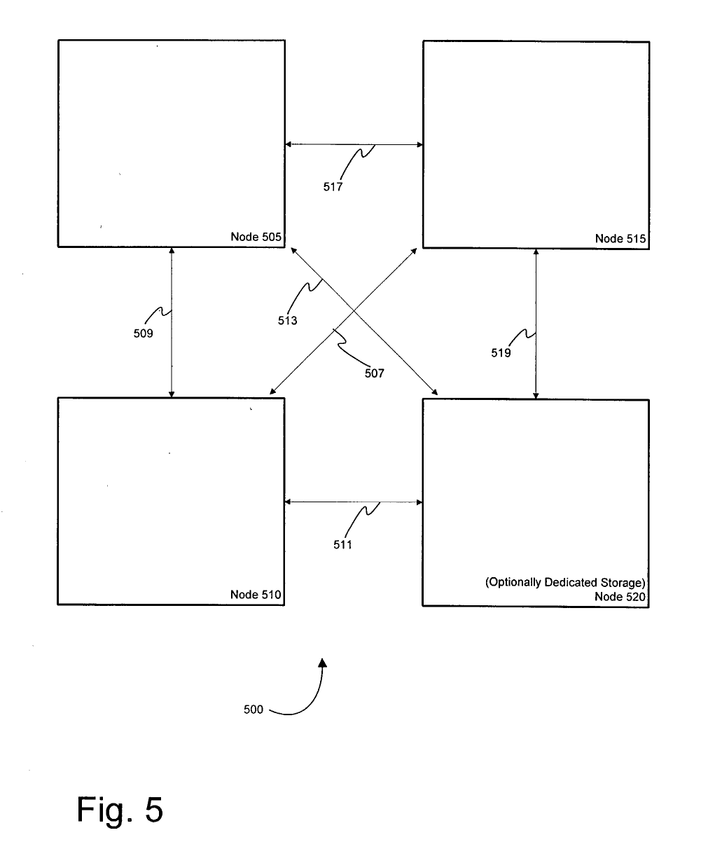

FIG. 5 illustrates an embodiment of a system 500 employing at least one processor utilizing disclosed signal observation techniques and a node that may be dedicated to storing data from such observation. In the embodiment of FIG. 5, four nodes are shown. In one embodiment, each node includes a processor and a bridge controller, as well as at least two link interfaces. Node memories (not shown) may be provided for each node and linked by a memory link interface. As shown, a node 505 is linked respectively by links 509, 513, and 517, to nodes 510, 520, and 515. Link 519 links nodes 515 and 520. Link 511 links nodes 510 and 520. Link 507 links nodes 510 and 515. In one embodiment, one of the nodes may be dedicated to trace capture. As shown, node 520 is optionally a dedicated storage node. Thus, trace records may be directed to node 520 for storage by the various other nodes.

The various systems shown throughout this disclosure may be various types of computer or computing systems, or other data processing or entertainment systems that employ electronic components. The increasing complexity of a great variety of electronic components imbues utility into the disclosed technique across a great variety of applications. Any component whose inner signaling may desirably be ported to a memory in a test mode for later analysis may benefit from these techniques. Such systems include, but are not limited to desktop computers, portable computers, personal digital assistants, tablet computers, phones, digital set-top boxes, entertainment devices, media readers or writers, and the like.

It is to be understood that any of the various “logic blocks” or “blocks” might be implemented as software or firmware, or any combination of hardware, firmware, software, and the like. Additionally, various blocks in flowchart form need not necessarily be performed sequentially, but may at times be performed in different orders or partially or fully in parallel.

Moreover, a design may go through various stages, from creation to simulation to fabrication. Data representing a design may represent the design in a number of manners. First, as is useful in simulations, the hardware may be represented using a hardware description language or another functional description language Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. An optical or electrical wave modulated or otherwise generated to transmit such information, a memory, or a magnetic or optical storage such as a disc may be the machine readable medium. Any of these mediums may “carry” the design information.

Thus, non-intrusive signal observation techniques which may be usable for real-time internal signal capture for an electronic module or integrated circuit are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure.

What is claimed is:

1. An apparatus comprising:
an observed bus;
observation logic operative in a test mode to capture a plurality of records that reflect a sequence of signals on said observed bus as said sequence of signals occurs;
preservation logic to cause preservation of said plurality of records within a system memory.

2. The apparatus of claim 1 wherein said plurality of records accurately reflects all relevant information from one or more of each event, each clock cycle, or each transaction on the observed bus.

3. The apparatus of claim 1 wherein said observation logic comprises reduction logic to generate said plurality of records to contain fewer bits than a sum of all bits for each and every bit of said observed bus during said sequence of signals.

4. The apparatus of claim 1 wherein said preservation logic comprises:
a debug buffer coupled to said observation logic to store said plurality of records observed by said observation logic.

5. The apparatus of claim 4 wherein said debug buffer comprises a portion of a cache memory and control logic to partition said portion of said cache memory for record capture and to allow a remainder of said cache memory to be used for normal system operation.

6. The apparatus of claim 5 wherein said cache memory comprises one of a processor cache or a directory cache.

7. The apparatus of claim 1 wherein said preservation logic comprises:
streaming logic to generate a transaction to transfer said plurality of records to a storage device.

8. The apparatus of claim 7 wherein said storage device is an off-chip storage device.

9. The apparatus of claim 7 wherein said streaming logic comprises an interface also used in a normal operation mode.

10. The apparatus of claim 1 wherein said observed bus comprises an internal bus wherein said apparatus further comprises:
a first logic block;
a second logic block coupled to the first logic block by said observed bus.

11. The apparatus of claim 1 wherein said observed bus comprises a set of signals having an external interface.

12. The apparatus of claim 10 wherein said first logic block comprises a processor and wherein said second logic block is one of a set consisting of a bridge controller, a link interface, a memory link interface, a crossbar, and another processor.

13. The apparatus of claim 4 wherein said preservation logic further comprises:
streaming logic to generate a transaction to transfer said plurality of records to a storage device to store said plurality of records.

14. The apparatus of claim 1 wherein said apparatus is any one or more of a set consisting of:
a processor;
a module comprising a plurality of integrated circuits;
a single integrated circuit;
a chip multi-processor;
at least one processor and an memory controller integrated into a single module.

15. The apparatus of claim 1 wherein said observation logic comprises:
filtering logic to filter out idle cycles from said observed bus.

16. The apparatus of claim 1 wherein said observation logic comprises:
compression logic to compress information from the observed bus into the plurality of records.

17. The apparatus of claim 16 wherein said compression logic is to eliminate information not relevant to a current bus cycle in generating a record.

18. The apparatus of claim 15 further comprising:
compression logic to eliminate information not relevant to a current bus cycle in generating a record.

19. The apparatus of claim 12 wherein said streaming logic is to generate a transaction to either of a node memory or a link to another agent.

20. The apparatus of claim 13 wherein said debug buffer operates in one of two modes, wherein in a first mode the transaction is generated at a priority level to compete with other transactions, and wherein in a second mode, said transaction is generated during idle cycles, wherein in said second mode, said debug buffer operates as a circular buffer and overwrites previous entries even if they have not been transferred to the storage device.

21. The apparatus of claim 1 wherein said apparatus comprises machine readable data carried on a machine readable medium.

22. The apparatus of claim 1 wherein said apparatus comprises one or more of hardware, software, and firmware.

23. A system comprising:
a system memory to store processor instructions in a first mode and to store trace sequences in a second mode;
a first node comprising a processor, a memory interface, an interface, and observation logic to capture an internal transaction sequence from information internal to said first node and to stream said internal transaction sequence to the system memory via said interface.

24. The system of claim 23 wherein said interface is one of a memory link interface or an interface port.

25. The system of claim 23 wherein in the first mode, said interface is used for normal system operation and wherein in the second mode, said interface is used to stream operations to store said internal transaction sequence to the system memory.

26. The system of claim 23 further comprising:
a second node coupled to said interface to selectively receive said internal transaction sequence.

27. The system of claim 23 wherein said system is one of a set consisting of a desktop computer system and a server computer system.

28. The system of claim 26 wherein said system comprises a plurality of nodes, wherein said second node is a dedicated test storage node comprising said system memory.

29. The system of claim 28 wherein said first node further comprises:
a debug buffer to store said internal transaction sequence.

30. The system of claim 29 wherein said observation logic comprises reduction logic to reduce a quantity of bits needed to represent said internal transaction sequence.

31. A method comprising:
capturing a sequence of bus transactions on an internal bus as the sequence of bus transactions occurs;
preserving said sequence of bus transactions in a system storage device.

32. The method of claim 31 wherein preserving comprises:
streaming the sequence of bus transactions to an external memory.

33. The method of claim 31 wherein preserving comprises:
storing the sequence of bus transactions in a cache.

34. The method of claim 33 wherein preserving further comprises:
streaming the sequence of bus transactions to a memory.

35. The method of claim 31 further comprising:
reducing a number of bits from the sequence of bus transactions to generate a plurality of records, wherein preserving said sequence of bus transactions comprises storing said plurality of records.

36. The method of claim 35 wherein reducing further comprises:
filtering out a plurality of idle cycles from said sequence of bus transactions;
compressing said sequence of bus transactions to remove irrelevant information.

37. An apparatus comprising:
a first sub-component;
a second sub-component;
a plurality of signal lines to couple said first sub-component and said second sub-component;
observation logic to capture a sequence of signals on said plurality of signal lines and to generate a representation of said sequence of signals having a reduced number of bits used to represent said sequence of signals;
preservation logic couple to said observation logic to store said representation of said sequence of signals in a system memory.

38. The apparatus of claim 37 wherein said system memory comprises an on-chip cache memory.

39. The apparatus of claim 37 wherein said system memory comprises an external memory.

40. An apparatus comprising:
means for observing a sequence of signals on a plurality of signal lines;
a system memory means for storing system data usable in normal operations;
means for storing said sequence of signals in said system memory means.

41. The apparatus of claim 40 further comprising:
means for reducing an amount of data required to store said sequence of signals in said system memory means coupled to provide a different representation of said sequence of signals than observed on said plurality of signal lines to said means for storing.

42. The apparatus of claim 40 wherein said means for observing is for observing said sequence of signals on the plurality of signal lines in a test mode, and further wherein said system memory means is also for storing test data representing said sequence of signals in said test mode.
